(19) United States
(12) Patent Application Publication
(10) Pub. No.: US 2010/0147542 A1
(43) Pub. Date: Jun. 17, 2010

(54) TOOL LIFTING

(75) Inventors: Lars Schmid, Nuertingen (DE); Andreas Strasser, Rudersberg (DE); Peter Loehnert, Miessingen (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/160,799

(22) PCT Filed: Jun. 19, 2007
(86) PCT No.: PCT/EP2007/056068

§ 371 Date: Jul. 14, 2008

(30) Foreign Application Priority Data
Aug. 8, 2006 (DE) 10 2006 036 955.6

(51) Int. Cl. B25D 17/08; B23B 31/107

(52) U.S. Cl. 173/90; 279/19.5; 279/75; 279/140

(57) ABSTRACT

The invention relates to a tool receptacle (1), in particular for a hammer drill and/or rotary hammer, comprising a receptacle body (2) which has an insertion opening (3) for accommodating a tool shank (4), an axially displaceable locking control element (41) for axially locking the tool shank (4) in the insertion opening (3), and a rotatably mounted locking control body (41) for rotationally locking the receptacle body (2). Provision is made for the locking control element and the locking control body to be designed as a common component (41).

The present invention relates to a tool fitting, in particular for a rotary hammer and/or a chisel hammer, with a receiving body that includes an insertion opening for receiving a tool shank, an axially displaceable locking control element for locking the tool shank in place axially in the insertion opening, and a rotatably supported locking control body to rotationally lock the receiving body.

### RELATED ART

In order to perform chiseling using a tool, e.g., a flat chisel, in various rotary positions, it is known to provide a rotary hammer and/or a chisel hammer with a tool fitting that enables tools to be replaced, and with which the tool may be moved into various rotary positions and locked in place. Publication DE 100 01 193 A1 describes a tool fitting for a hand-held power tool, with which, to axially lock or unlock a tool shank, a locking control element with a first actuating sleeve is displaced axially, and a locking control body with a second actuating sleeve is rotated in order to change the rotary position of the receiving body. The separate locking control element and the separate locking control body and their actuating sleeves are limited by the amount of space available inside the tool fitting, however.

### DISCLOSURE OF THE INVENTION

With the inventive tool fitting, it is provided that the locking control element and the locking control body are designed as a common component. Combining the two control functions in a common component results in a marked increase in operating comfort for the user of a hand-held power tool. Due to the amount of space that is freed up by combining the locking control element and the locking control body, the single-handed operation of adjusting the rotational position of a tool inserted in the tool fitting and locking it in place, and of locking its tool shank in position axially in the receiving body is made much more user-friendly.

According to a refinement of the present invention, a locking body that is non-rotatably supported on the receiving body is provided to rotationally lock the receiving body. When the locking body is rotationally locked in place such that it is secured in the housing, the receiving body and the tool shank accommodated in the receiving body are rotationally locked. The rotational lock is realized, e.g., via a non-positive and/or form-fit connection, in the direction of rotation between an element that is secured in the housing, and the locking body.

It is advantageously provided that the locking body is supported on the receiving body in an axially displaceable manner, and that it may be moved between a non-rotatable position and a rotatable position. To this end, the locking body includes, e.g., at least one projection, which engages in a longitudinal groove in the outer jacket of the receiving body and guides the locking body in the longitudinal direction of the receiving body. To this end, the locking body wraps around, e.g., the receiving body.

It is advantageously provided that the locking body includes a toothing, with which it bears—in a non-rotatable position—in a counter-structure of a housing part. To this end, the counter-structure of the housing part may be designed as a counter-toothing that engages—in the non-rotatable position—in the toothing, thereby establishing a form-fit connection and non-rotatably supporting the locking body in the housing part. The detent ring advantageously includes a toothing with recesses having cross sections that are at least partially trapezoidal, and/or trapezoidal teeth, via which large torques may be transferred.

It is further provided that the common component and the locking body form a rearward-engagement structure for the axial displacement of the locking body between the non-rotatable position and the rotatable position of the locking body, and for rotating the locking body. The rearward-engagement structure serves to displace the locking body axially from the non-rotatable position into a rotatable position, to then rotate it together with the receiving body, and, finally, to move it back into the non-rotatable position. The locking body is a detent ring in particular. By using a detent ring, a short overall length may be realized, and a radial distance between the receiving body and the common component may be bridged. When the locking region for the rotational locking—which is secured in the housing—of the locking body designed as a detent ring is located in the region of the radially outer diameter, a particularly large transfer surface may be used to realize a non-positive and/or form-fit connection.

The rearward-engagement structure is advantageously designed as a slot link of the common component, with which a projection of the locking body engages. To this end, the slot link and the projection have a matching curved contour, which ensures that the locking body is initially displaced axially, and is then rotationally locked.

According to a refinement of the present invention, a locking element is provided for axially locking the tool shank in the insertion opening, which may be moved axially between a locking position and a release position. This motion is controlled by the position of the common component.

A rotatable and/or axially displaceable control element for axially displacing and/or rotating the common component are/is also provided. The control element is preferably designed as a control sleeve, which encloses at least a portion of the common component in the manner of a jacket. The control element is preferably preloaded in the axial direction by a spring element, in order to define a neutral position. A motion of the control element (an axial motion and/or a rotational motion) may then be transferred to the locking element, which takes place, e.g., by the control element driving the common component. As an alternative, the control element is rigidly or elastically coupled with the common component, so that the motion of the control element is transferred to the common component.

At least one locking bolt, which is supported in the locking element and is radially displaceable between a locking position and a release position, is also provided, which, in its locking position, locks the locking element in place axially and, in its release position, releases it axially. When the locking bolt is in the locking position, the locking element is locked in position in the release position, so that the tool shank may be inserted into or removed from the tool fitting, without the user having to hold the locking element in place (single-hand operation). When the locking bolt is in the release position, however, the locking element is not locked in place in the release position, thereby allowing the tool shank to be locked in place axially in the tool fitting. To release the locking position, the locking bolt is released from its locking position, in particular via an axial displacement of the tool shank. The displacement motion of the tool shank that occurs when the tool shank is removed from or inserted into the tool fitting is transferred to the locking bolt, thereby releasing it from its locking position.

A spring element is advantageously provided, which preloads the locking bolt in the direction of the locking position. In the locking position, the locking bolt bears in particular against an axial stop in the receiving body. Due to the spring preload, the locking bolt is automatically moved into the locking position when the user moves the locking element out of the locking position and into the release position. In the release position, no operator intervention is required to lock the locking element in place, which simplifies operation considerably.

According to a refinement of the present invention, a release element that is supported in the receiving body such that it is displaceable in the radial direction is provided to release the locking bolt from the locked position. The release element may be displaced by the tool shank in the radially outward direction against the locking bolt. To this end, a release element designed as a ball in particular is provided to transfer force from the tool shank to the locking bolt. The release element extends radially into the insertion opening of the tool fitting and, when the tool shank is inserted or removed, it is displaced radially outwardly, thereby pressing the locking bolt radially outwardly. When the release element is designed as a ball that is supported in an opening in the receiving body in a radially displaceable manner, the opening is preferably tapered conically inwardly. This shape prevents the ball from falling out toward the inside when a tool shank is not present in the tool fitting.

A spring device is also provided, which preloads the locking element axially in the direction of the locking position and/or which preloads the locking body axially in the direction of the non-rotatable position. Via a locking element that is preloaded in this manner, the tool shank and rotational lock are prevented from becoming accidentally released.

It is advantageously provided that at least one radially displaceable blocking element is located in the receiving body for locking the tool shank in place axially, it being possible for the blocking element—in the locking position of the locking element—to engage in longitudinal grooves of the tool shank. The tool shank, which has been inserted in the receiving body, is locked in place axially by the blocking element that has engaged in a longitudinal groove of the tool shank. In the locked state, the tool shank therefore has only a certain amount of motional play in the axial direction. When the locking element is in the locking position, the blocking element is prevented from deflecting radially. When the locking element—depending on the position of the common component—is located in the unlocking position, the blocking element may become displaced radially outwardly, and the tool shank of the tool may be removed from or inserted into the tool fitting. The blocking elements are advantageously designed as locking rollers, which undergo very little wear during operation.

It is further provided that the locking element is the common component, or it includes the common component. When the locking element is designed as a single piece and controls/determines the position and orientation of the locking body, the locking element is the common component. When the locking element includes a component that determines the position and orientation of the locking body, the locking element includes the common component.

The present invention also includes a hand-held power tool, in particular a rotary hammer and/or chisel hammer, with an inventive tool fitting.

### BRIEF DESCRIPTION OF THE DRAWING

The drawing serves to explain the present invention, with reference to several exemplary embodiments:

FIG. 1a shows a cross-section of a tool fitting in a non-rotatable position and a locking position,

FIG. 1b shows a cross-section of the tool fitting in FIG. 1 in a rotatable position and a locking position,

FIG. 1c shows a cross-section of the tool fitting in FIG. 1a in a non-rotatable position and a locking position,

FIGS. 2a through c show cross-sections of a second exemplary embodiment of an inventive tool fitting according to FIGS. 1a through c,

FIGS. 3a through c show a cross-section of a third exemplary embodiment of an inventive tool fitting according to FIGS. 1a through c, and

FIGS. 4a through d are schematic depictions of the control of a locking body via a common component.

### EMBODIMENTS(S) OF THE INVENTION

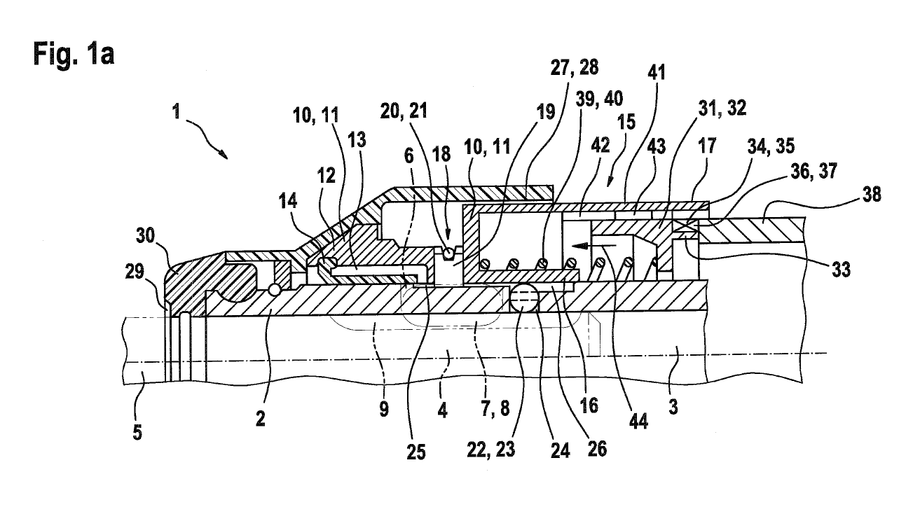

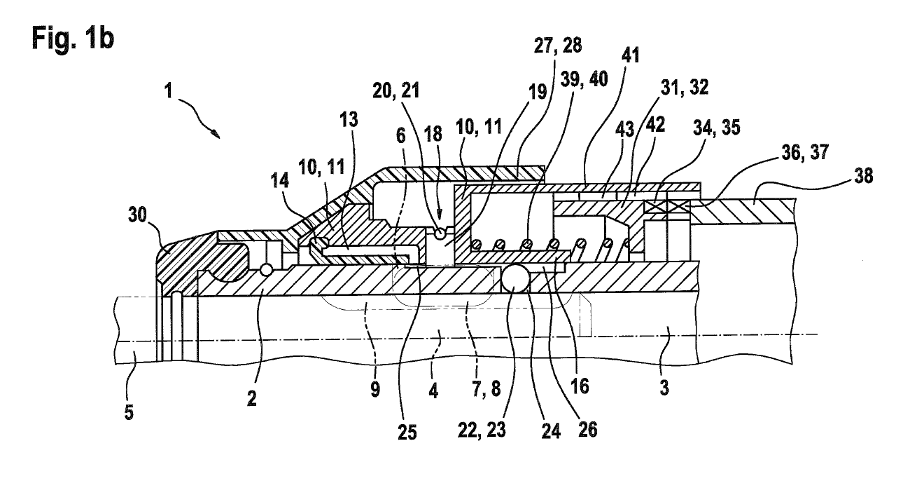

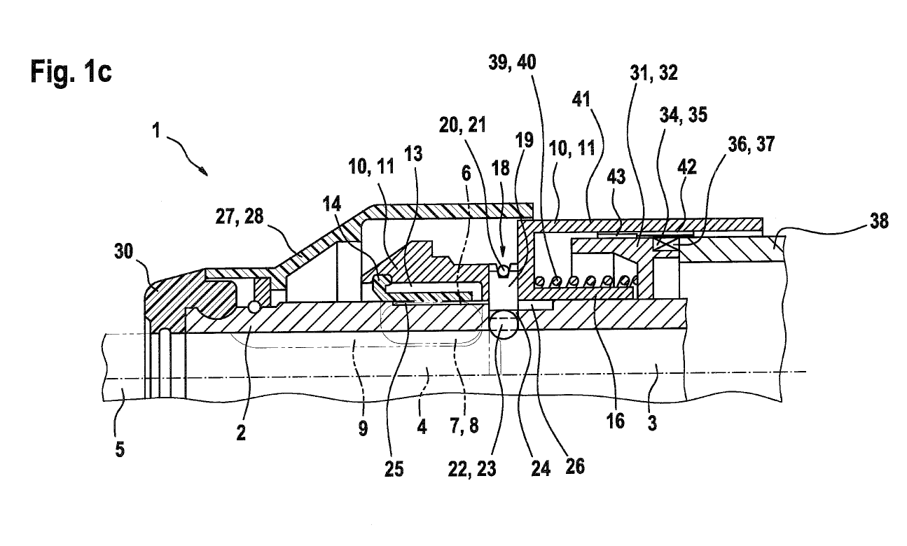

FIGS. 1a through 1c show a tool fitting 1 for a rotary hammer and/or a chisel hammer. Tool fitting 1 includes an essentially hollow-cylindrical receiving body 2 with an insertion opening 3, in which a tool shank 4 of a tool 5—which is not shown in entirety—has been inserted. Receiving body 2 includes several openings 6 distributed around the circumference, in each of which a blocking element 8 designed as a locking roller 7 is present. Openings 6 taper inwardly in the radial direction. Tool shank 4 includes—in its shell—a longitudinal groove 9 that extends beyond the axial section with locking roller 7, in which locking roller 7 engages. Tool fitting 1 also includes a locking element 11 designed as a locking sleeve 10, which encloses receiving body 2 in the region of tool fitting 1. At its first end 12, locking element 11 has clearance from receiving body 2, which results in the formation of cavity 13. An elastic boot 14 is located in cavity 13, which is located directly on the circumferential surface of receiving body 2. On a second end 15 that is opposite to first end 12 of locking element 11, locking element 11—which is designed as locking sleeve 10—includes an inner sleeve 16, which encloses receiving body 2 directly, and a radially outwardly-located outer sleeve 17. Locking element 11 includes a locking device 18 between first end 12 and second end 15. Locking device 18 is composed, e.g., of a locking bolt 19, which is supported in a radially extending hole in locking element 11 such that it is radially displaceable. Locking bolt 19 is preloaded radially inwardly by a spring element 21 that is designed as an annular spring 20. Locking device 18 also includes a release element 23 designed as a ball 22, which is supported in a radially extending opening 24 in receiving body 2 such that it may be displaced radially. Opening 24 tapers inwardly in the radial direction, thereby enabling release element 23 to extend inwardly only partially into insertion opening 3. Locking bolt 19 is guided in two axially extending grooves 25, 26 provided in the shell of receiving body 2 on either side of opening 24. Groove 25 on the workpiece side is shallower than groove 26 on the tool side. To operate tool fitting 1, locking element 11 designed as locking sleeve 10 is enclosed at least partially in the axial direction by a control element 28 designed as control sleeve 27. Control element 28 is displaceable in the axial direction, and it is preloaded via a not-shown spring element in the axial direction of the workpiece and a dust boot 30 located on the front end. Dust boot 30 is elastic in design, to prevent dust from entering insertion opening 3 during operation and with the tool shank inserted. A locking body 32 designed as detent ring 31 is located at the level of second end 15 of locking element 11, between receiving body 2 and outer sleeve 17 of locking element 11. Detent ring 31 is provided—on the outer circumference of its side facing away from the workpiece—with a toothing 35 designed as outer gear ring 34, which, e.g., in FIG. 1a, is operatively engaged with a counter-structure 37 of a housing part 38, which is secured in the housing and is designed as inner gear ring 36. Counter-structure 37 prevents locking body 32 from rotating. Locking body 32 is supported in a non-rotatable but axially displaceable manner by not-shown projections of locking body 32 on its inner radius, which engage in not-shown longitudinal grooves in the shell of receiving body 2. When locking body 32 is located as shown in FIG. 1a, toothing 35 of locking body 32 engages in counter-structure 37 of housing part 38, and comes to bear there, so that, via locking body 32, receiving body 2 and, possibly, a tool shank 4 inserted in receiving body 2 are also rotationally locked. A spring device 40 that is located between locking element 11 and locking body 32 and is designed as compression spring 39 preloads locking element 11 in the direction of the locking position, and it preloads locking body 32 in the direction of the non-rotatable position.

In the first exemplary embodiment, depicted in FIGS. 1a through c, locking element 11 is designed as common component 41, which determines and/or controls the axial locking of tool shank 4 in receiving body 2 and the rotational locking of receiving body 2.

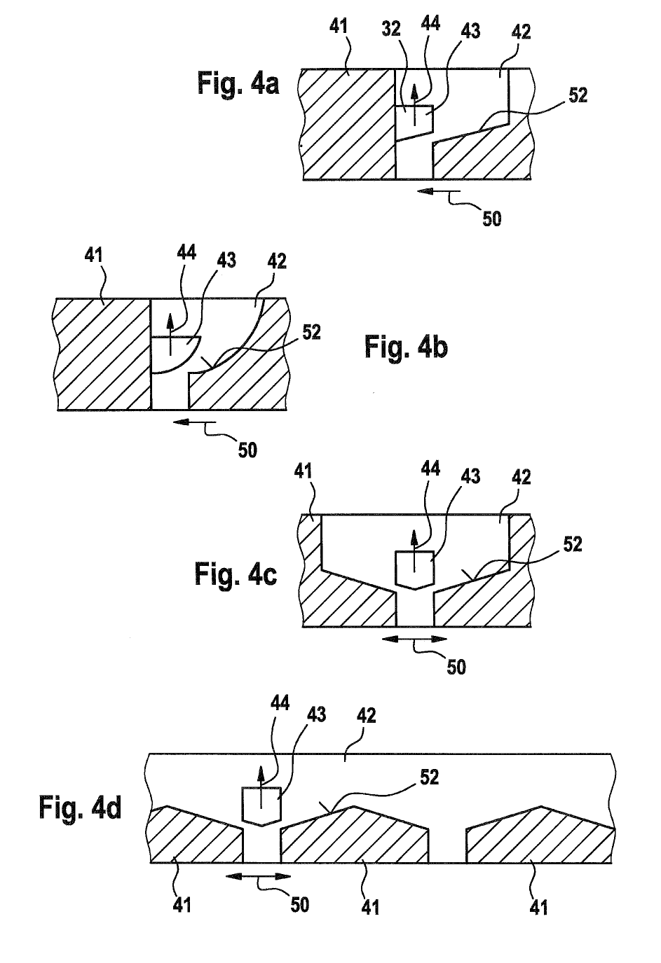

The control of the axial locking results directly from the fact that locking sleeve 10 forms common component 41. To control the rotational locking, common component 41 includes—at the level of locking body 32, which is designed as detent ring 31—a slot link 42 shown in FIGS. 4a through 4d, in which a projection 43 of locking body 32 engages. Together, slot link 42 and projection 43 form a rearward-engagement structure for axially displacing locking body 32 between the non-rotatable position and the rotatable position of locking body 32 and, therefore, of receiving body 2. When common component 41 is rotated, as shown in FIGS. 4a through d, locking body 32 is initially displaced axially in the direction toward end 29 of tool fitting 1 (arrow 44) until toothing 35 and counter-structure 37 are no longer operatively engaged with each other.

This is the situation is shown in FIG. 1b. When common component 41 (i.e., locking element 11 in this case) is rotated further, locking body 32 and, with it, receiving body 2 are rotated, thereby allowing it to be moved by compression spring 39 back into a non-rotatable position that follows the direction of rotation. FIG. 1b is essentially the same as FIG. 1a, but with locking body 32 in the axially displaced, rotatable position.

Tool shank 4 is locked in place in receiving body 2 as follows: When tool shank 4 is inserted axially into insertion opening 3, the tool shank presses locking rollers 7 radially outwardly until locking roller 7 engages—in a locked position of tool shank 4—in longitudinal groove 9 of tool shank 4 (FIG. 1c). As tool shank 4 is inserted further, release element 23 is displaced radially outwardly, and locking bolt 19 is also pressed radially outwardly, against the preload of annular spring 20. When locking bolt 19 is lifted above the step between the two grooves 25, 26, compression spring 39 pushes locking element 11 axially into the locking position shown in FIG. 1a, and locking bolt 19 is guided in groove 25. In the locking position, locking element 11 covers—with its inner side—opening 6 of blocking element 8, which is therefore prevented from moving radially outwardly, thereby locking tool shank 4 in place axially. Tool shank 4 is therefore locked in place without further user intervention when it is inserted into receiving body 2. To remove tool shank 4 from receiving body 2, the locking element must first be moved from the locking position shown in FIG. 1a into the release position shown in FIG. 1c. To this end, the user slides control sleeve 27 axially out of the position shown in the figures and in the direction toward locking element 11. Control element 28 displaces locking element 11 axially until locking bolt 19 is located in groove 26 on the tool side behind release element 23, thereby bearing against release element 23 (i.e., ball 22). The user then releases control element 28, which returns to its starting position due to the restoring force of the not-shown spring element. Locking element 11 is not locked in place axially by release element 23 and locking bolt 19, since locking bolt 19 bears laterally against release element 23, while release element 23 is pressed outwardly by the shell of tool shank 4. It should be mentioned that longitudinal groove 9 and blocking element 8 are not in the angular range—in the circumferential direction—in which release element 23 is located. In the release position (FIG. 1c) of locking element 11, which is designed as common element 41, it is not possible to displace locking body axially or to rotate it, due to the shape of slot link 42.

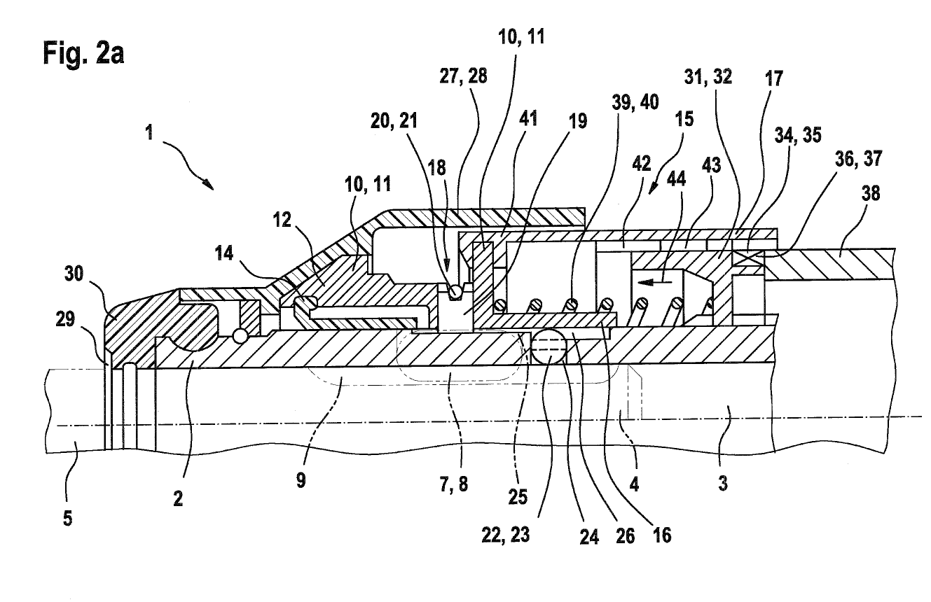

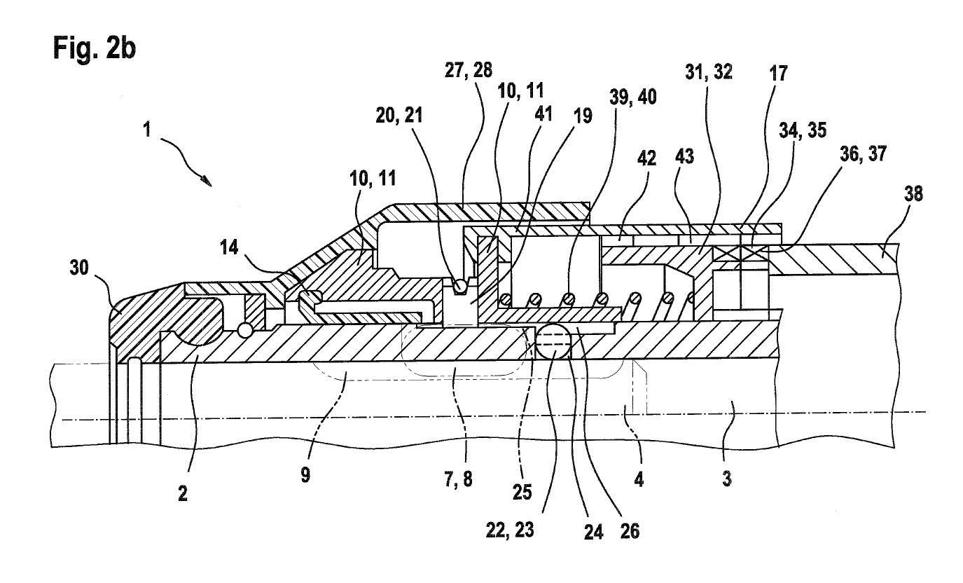

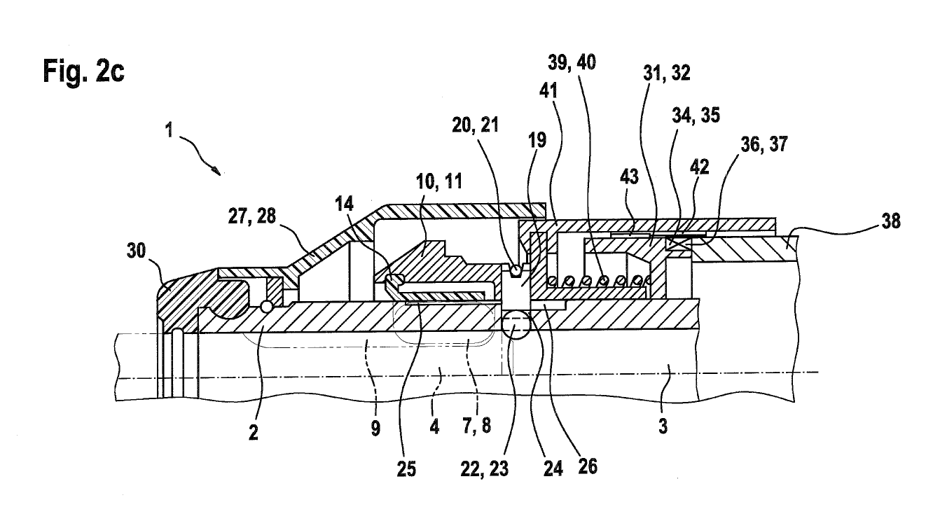

FIGS. 2a through c show the analogous positions of locking element 11 and locking body 32 for a further exemplary embodiment of tool fitting 1. In this exemplary embodiment, locking element 11 and/or common component 41 are not designed as one piece, but rather include outer sleeve 17 as a separate component. In this exemplary embodiment, outer sleeve 17 is therefore common component 41. The functions of the first exemplary embodiment (FIGS. 1a through c) and the second exemplary embodiment (FIGS. 2a through c) are the same.

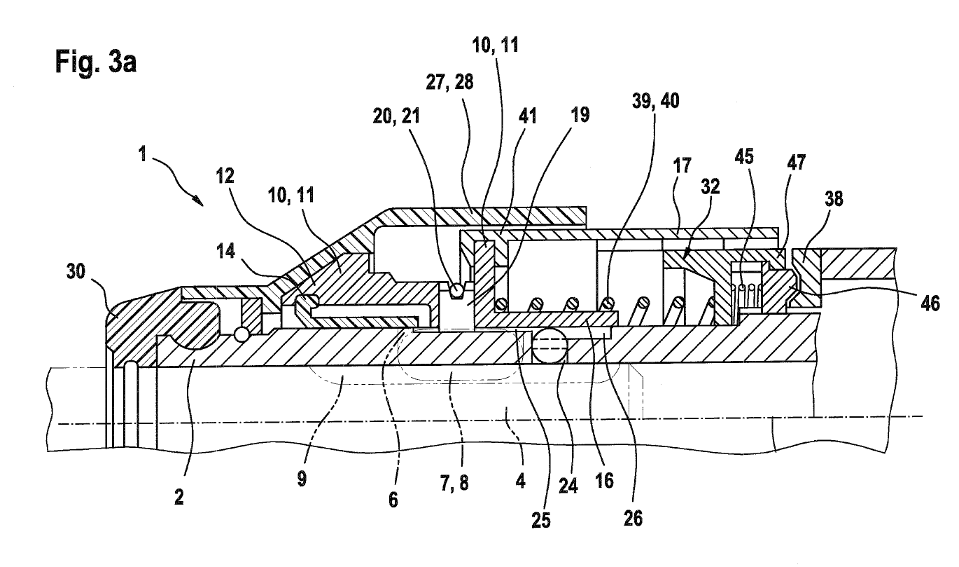

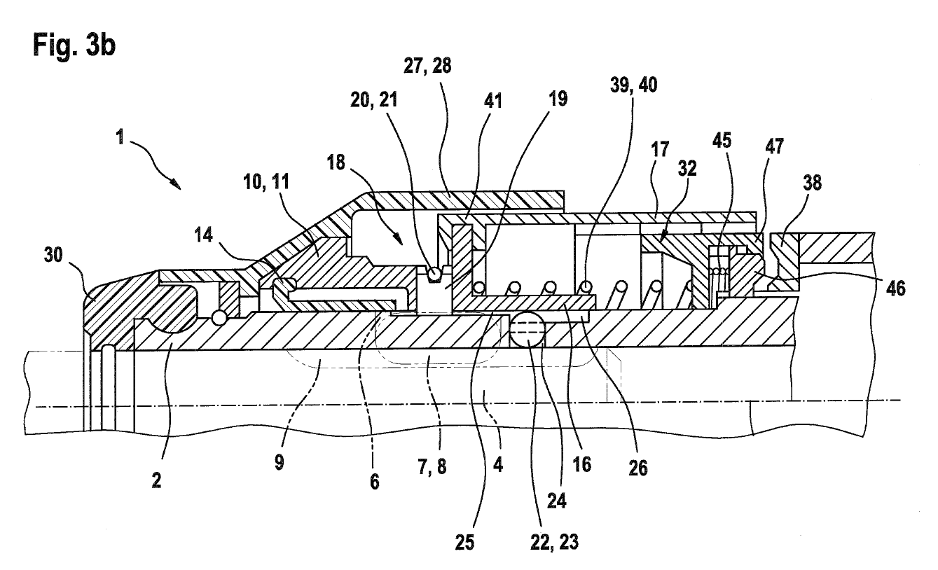

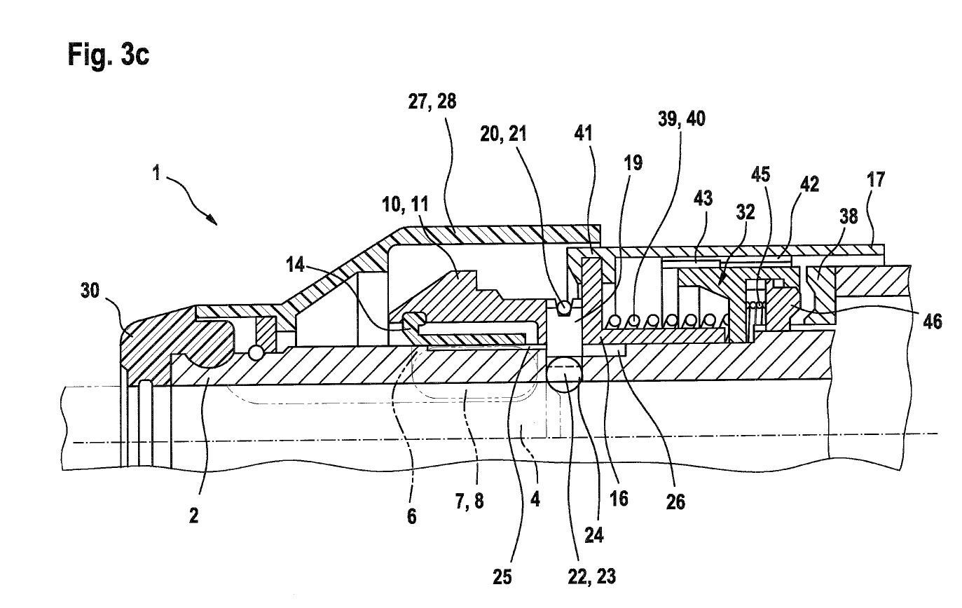

FIGS. 3a through c show a third exemplary embodiment of inventive tool fitting 1, which essentially corresponds to the second exemplary embodiment and includes a locking element 11 with a separate outer sleeve 17. Locking body 32 of the third exemplary embodiment is composed of several components and includes a spring element 45 designed as a compression spring, a snap-in disk 46, and a driving projection 47. Locking body 32 does not engage directly via a toothing 35 in a counter-structure 37 of housing part 38. Instead, locking body 32 presses snap-in disk 46 with a toothing 48 via spring element 45 into a counter-structure 37 of housing part 38. Common component 41 is rotated in the clockwise direction in order to adjust the tool. Locking body 32 is carried along and pulls—via its driving projection 47—snap-in disk 46 out of counter-structure 37 of housing part 38. When common component 41 is rotated further, a defined driving point of slot link 42 is engaged and rotates locking body 32 and receiving body 2. Acted upon by spring element 45, snap-in disk 46 slides into the next toothing position of housing part 38.

FIGS. 4a through d show four possible variants of curve contours 49 of a slot link 42 and a corresponding curve contour of projection 43 of locking body 32. When common component 41 is rotated (arrow 50), projection 43 and, therefore, locking body 32 are displaced axially in the direction toward end 29, until toothing 35 and counter-structure 37 are no longer operatively engaged with each other, thereby allowing locking body 32 to rotate with common component 41. Slot link 42 as shown in the variants in FIGS. 4a and 4b may only be rotated in one direction (arrow 50), while, in the variant shown in FIGS. 4c and 4d, slot link 42 may be rotated in both directions (double arrow 51).

The mode of operation is as follows: With slot link 42 shown in FIG. 4a, locking body 32 is displaced axially by rotating the common component over a slanted edge 52. With slot link 42 shown in FIG. 4b, locking body 32 is displaced axially by rotating common component 41 over any type of curved contour 53. With slot link 42 shown in FIG. 4c, locking body 32 is displaced axially by rotating common component 41 in both directions either over a slanted edge 52 or over any type of curved contour 53. With slot link 42 shown in FIG. 4d, locking body 32 is displaced axially by rotating common component 41 in both directions over a repeating slanted edge 52 or over any type of curved contour 53.

1-15. (canceled)

16. A tool fitting for a rotary hammer and/or a chisel hammer, comprising: a receiving body that includes an insertion opening for receiving a tool shank; an axially displaceable locking control element for locking the tool shank in place axially in the insertion opening; a rotatably supported locking control body to rotationally lock the receiving body, the locking control element and the locking control body being designed as a common component (41); and a locking body (32) that is non-rotatably supported on the receiving body (2), for rotationally locking the receiving body (2),
wherein
the locking body (32) is supported on the receiving body (2) in an axially displaceable manner, and may be moved between a non-rotatable position and a rotatable position.

17. The tool fitting as recited in claim 16,
wherein
the locking body (32) includes a toothing (35), with which it bears—in the non-rotatable position—in a counter-structure (37) of a housing part (38).

18. The tool fitting as recited in claim 17,
wherein
the common component (41) and the locking body (32) form a rearward-engagement structure for the axial displacement of the locking body (32) between the non-rotatable position and the rotatable position of the locking body (32), and for rotating the locking body (32).

19. The tool fitting as recited in claim 18,
wherein
the rearward-engagement structure is formed by a slot link (42) of the common component (41) and a projection of the locking body.

20. The tool fitting as recited in claim 16, and further comprising a locking element (11) for axially locking the tool shank (4) in the insertion opening (3), which may be moved axially between a locking position and a release position.

21. The tool fitting as recited in claim 16, and further comprising a rotatable and/or axially displaceable control element (28) for axially displacing and/or rotating the common component (41).

22. The tool fitting as recited in claim 20, and further comprising at least one locking bolt (19), which is supported in the locking element (11) and is radially displaceable between a locking position and a release position, which, in its locking position, locks the locking element (11) axially and, in its release position, releases it axially.

23. The tool fitting as recited in claim 22, and further comprising a spring element (21), which preloads the locking bolt (19) in the direction toward the locking position.

24. The tool fitting as recited in claim 22, and further comprising a release element (23), which is supported in the receiving body (2) in a radially displaceable manner and serves to release the locking bolt (19) from the locking position.

25. The tool fitting as recited in claim 20, and further comprising a spring device (40), which preloads the locking element (11) axially in the direction toward the locking position and/or which preloads the locking body (32) axially in the direction toward the non-rotatable position.

26. The tool fitting as recited in claim 16,
wherein
at least one radially displaceable blocking element (8) is located in the receiving body (2) for locking the tool shank (4) in place axially, it being possible for the blocking element (8)—in the locking position of the locking element (11)—to engage in a longitudinal groove (9) of the tool shank (4).

27. The tool fitting as recited in claim 20,
wherein
the locking element (11) is the common component (41) or it includes the common component (41).

28. A hand-held power tool comprising a tool fitting for a rotary hammer and/or a chisel hammer, comprising: a receiving body that includes an insertion opening for receiving a tool shank; an axially displaceable locking control element for locking the tool shank in place axially in the insertion opening; a rotatably supported locking control body to rotationally lock the receiving body, the locking control element and the locking control body being designed as a common component (41); and a locking body (32) that is non-rotatably supported on the receiving body (2), for rotationally locking the receiving body (2),
wherein
the locking body (32) is supported on the receiving body (2) in an axially displaceable manner, and may be moved between a non-rotatable position and a rotatable position.
